(19) United States
(12) Patent Application Publication
(10) Pub. No.: US 2020/0283285 A1
(43) Pub. Date: Sep. 10, 2020

(54) MULTI-LENGTH TUFT FEEDER

(71) Applicant: Paul Rodgers, Bacup (GB)

(72) Inventor: Paul Rodgers, Bacup. Lancashire (GB)

(73) Assignees: Paul Rodgers, Bacup (GB); David Trickett, Bacup (GB)

(21) Appl. No.: 16/759,470

(22) PCT Filed: Oct. 16, 2018
(86) PCT No.: PCT/GB2018/052980

§ 371 Date: Apr. 27, 2020

(30) Foreign Application Priority Data
Oct. 31, 2017 (GB) 1717998.7

(51) Int. Cl. B68G 7/08; B68G 15/00

(52) U.S. Cl. CPC B68G 7/08; D10B 2505/08; B68G 15/00

(57) ABSTRACT

Upholstery tufting apparatus comprises an insertion needle (5) with an aperture (4) to receive a tuft for insertion into an article to be upholstered. The tuft is presented to the needle aperture (4) along a tuft feed axis (3). The apparatus has a plurality of tuft strings (2a, 2b, 2c), a first string (2a) with tufts of a first length and a second string (2b) with tufts of different second length. The apparatus has one or more tuft feed units, and an actuator operatively connected to said tuft feed unit(s). The first and second tuft strings (2a, 2b) are associated with the tuft feed unit(s). A selected one of the tuft feed unit(s) is actuatable by the actuator to align one of the first and second strings (2a, 2b) with the tuft feed axis (3) according to the length of tuft required to be inserted into an article to be upholstered. A method for tufting an upholstered article employing said apparatus is also described.

The present invention relates to an automatic upholstery tufting method and apparatus therefor, particularly but not exclusively, for tufting such articles as mattresses, cushions and the like. Tufting is widely used to support and strengthen upholstered articles, such as mattresses.

Tufting typically involves the insertion of an elongate flexible element such as a tape or string interconnecting a pair of toggles (the whole hereinafter referred to as a “tuft”) through a mattress so that one toggle resides on either side of the mattress. The mattress is usually compressed during insertion of the tuft and allowed to expand once the tufting process has been completed.

The tufting process is often carried out using an automatic tufting apparatus. European Patent No. EP1167279 discloses a device and method for automatically tufting upholstery. The device comprises an engagement means, a separating means and a driving means for driving one tuft from a plurality of tufts through an upholstery unit. European Patent No. EP1474354 discloses an automatic tufting method and apparatus therefor. The apparatus comprises three main constituent units: a tuft feed unit, a washer feed unit and an insertion needle. The tuft feed unit feeds and inserts individual tufts from a string of tufts into the insertion needle.

The length of the tuft is marginally less than the depth of the mattress; therefore the region of the mattress near the tuft remains slightly compressed following expansion of the mattress after insertion. As mattresses are available in varying depths, different lengths of tufts are required. In the use of current automatic tufting devices it is a laborious task to reset the tufting apparatus to function with a different length of tuft, whether this is by changing the plurality of tufts fed into the apparatus, or adjusting mechanical settings.

An object of the present invention is therefore to provide an efficient tufting apparatus that is capable of selectively inserting tufts of different lengths according to the depth of the mattress.

According to a first aspect of the invention an upholstery tufting apparatus comprises an insertion needle. The insertion needle comprises an aperture to receive a tuft for insertion into an article to be upholstered. In use, the tuft is presented to the aperture of the insertion needle along a tuft feed axis. The upholstery tufting apparatus further comprises a plurality of tuft strings. A first tuft string comprises a plurality of tufts of a first length. A second tuft string comprises a plurality of tufts wherein each tuft is a second length which is different to said first length. The upholstery tufting apparatus further comprises one or more tuft feed units. The upholstery tufting apparatus further comprises an actuator connected to said one or more tuft feed units. The first tuft string and the second tuft string are associated with said one or more tuft feed units. A selected one of said one or more tuft feed units is actuatable by the actuator to align one of the first and second tuft strings with the tuft feed axis according to the length of tuft required, in use, to be inserted into an article to be upholstered.

In a preferred embodiment, there may be provided a plurality of tuft feed units. A first tuft feed unit of said plurality of tuft feed units may be associated with the first tuft string. A second tuft feed unit of said plurality of tuft feed units may be associated with the second tuft string.

In a further embodiment the plurality of tuft feed units may be arranged in a linear array. The actuator may be operated, in use, to move the linear array of tuft feed units so as to align the tuft feed string associated with the selected one of the plurality of tuft feed units with the tuft feed axis. The actuator may be operated, in use, to move the selected one of the plurality of tuft feed units so as to align the tuft feed string associated with said selected one of the plurality of tuft feed units with the tuft feed axis.

In a further embodiment the plurality of tuft feed units may be arranged in an array around the tuft feed axis. The actuator may be operated, in use, to move the selected one of the plurality of tuft feed units to align the tuft feed string associated with said selected one of the plurality of tuft feed units with the tuft feed axis.

In a further preferred embodiment the plurality of tuft feed units may be arranged in a circular array around the tuft feed axis. The actuator may be operated, in use, to move the selected one of the plurality of tuft feed units in a radial direction to align the tuft feed string associated with said selected one of the plurality of tuft feed units with the tuft feed axis.

In a further embodiment the plurality of tuft feed units may be arranged in a circular array centred on an axis which is offset from said tuft feed axis and which extends parallel to the tuft feed axis. The tuft feed axis may be aligned with a point on a circle defined by said circular array. The actuator may be operated, in use, to rotate the circular array of tuft feed units so as to align the tuft feed string associated with the selected one of the plurality of tuft feed units with the tuft feed axis.

In a further preferred embodiment, the or each of said one or more tuft feed units may comprise a rodless air cylinder.

In a further embodiment the actuator may be a pneumatic actuator.

In a further embodiment the upholstery tufting apparatus may further comprise a selector and a controller. The selector may determine the length of tuft required for insertion into said article to be upholstered. The selector may select an output according to the determined length of tuft required. The controller may control the actuator according to the output of the selector. The controller may be a servo controller.

A second aspect of the invention provides a method for tufting an upholstered article using apparatus of the first aspect of the invention comprises the step of operating a selector to select the length of tuft required to be inserted into the upholstered article. The method further comprises the step of operating a controller to control the actuator, according to the length of tuft selected by the selector, to move said selected one of said one or more tuft feed units to align said one of the first and second tuft string with the tuft feed axis according to the selected length of tuft to be inserted into the article to be upholstered. The method further comprises the step of operating he tuft insertion needle to insert the tuft of the selected length into the upholstered article.

Any of the optional features of the apparatus according to the first aspect of the present invention may be employed in the method according to the second aspect of the invention.

According to a third aspect of the invention an upholstery tufting apparatus comprises an insertion needle. The insertion needle comprises an aperture to receive a tuft for insertion into an article to be upholstered. In use, the tuft is presented to the aperture of the insertion needle along a tuft feed axis. The upholstery tufting apparatus further comprises a plurality of tuft strings. A first tuft string comprises a plurality of tufts of a first length. A second tuft string comprises a plurality of tufts of a second length. The upholstery tufting apparatus further comprises one or more tuft feed units. The upholstery tufting apparatus further comprises an actuator operatively connected to the insertion needle. The first tuft string and the second tuft string are associated with said one or more tuft feed units. The insertion needle is actuatable by the actuator to align the tuft feed axis with a selected one of the first and second tuft strings according to the length of tuft required, in use, to be inserted into an article to be upholstered.

Where technically feasible, any of the optional features of the apparatus according to the first aspect of the present invention may be employed in the apparatus according to the third aspect of the invention.

A fourth aspect of the invention provides a method for tufting an upholstered article using apparatus according to the third aspect of the invention comprises the step of operating a selector to select the length of tuft required to be inserted into the upholstered article. The method further comprises the step of operating a controller to control the actuator, according to the length of tuft selected by the selector, to move said insertion needle to align the tuft feed axis with the selected one of the first and second tuft strings according to the selected length of tuft to be inserted into the article to be upholstered. The method further comprises the step of operating the tuft insertion needle to insert the tuft of the selected length into the upholstered article.

Where technically feasible, any of the optional features of the apparatus according to the first aspect of the present invention may be employed in the method according to the fourth aspect of the invention.

Embodiments of the present invention will now be described, by way of example only, with reference to the accompanying drawings in which:

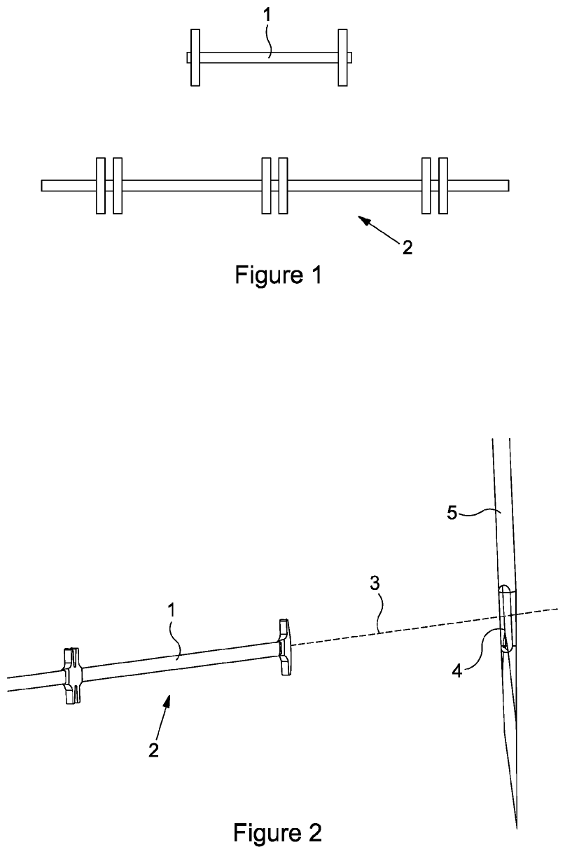

FIG. 1 is a plan view of a single tuft and a plurality of connected tufts to be used with apparatus of the present invention;

FIG. 2 is a schematic view of a string of tufts aligned with an aperture defined by a tuft insertion needle to define a tuft feed axis;

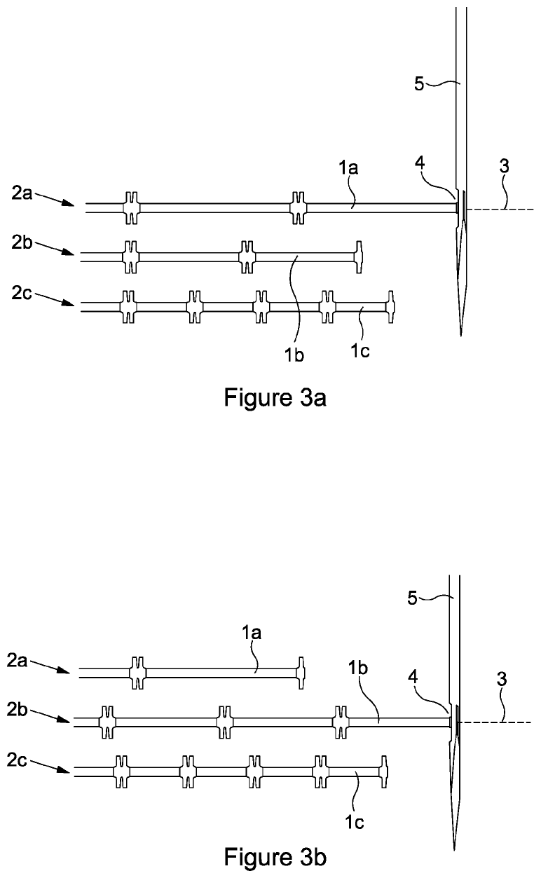

FIGS. 3a and 3b are schematic side views of multiple strings of different length tufts adjacent a tuft insertion needle wherein the tuft strings extend parallel to one another;

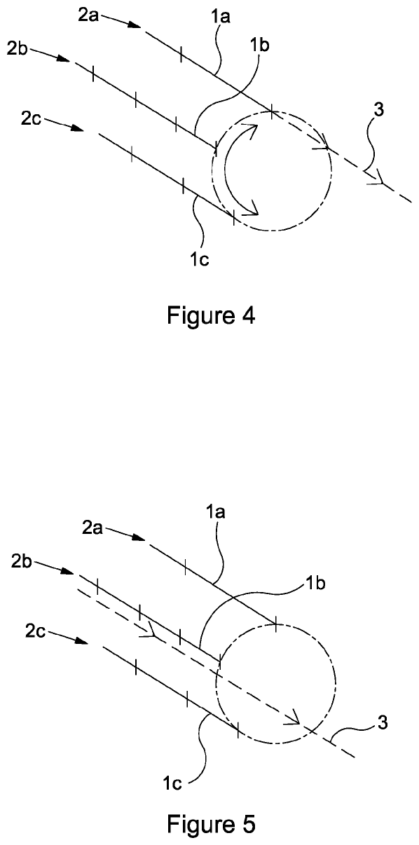

FIG. 4 is a schematic view of multiple strings of different length tufts wherein the tuft strings are arranged around a circumference and a tuft feed axis intersects the circumference; and

FIG. 5 is a schematic view of multiple strings of different length tufts wherein the tuft strings are arranged circumferentially around a tuft feed axis.

Apparatus according to a first embodiment of the present invention comprises a plurality of tuft feed units and an insertion needle which interact to insert a tuft of a required length, into a mattress. A tuft feed unit is aligned so as to insert an individual tuft 1 from a tuft string 2 (see FIG. 1) along a tuft feed axis 3 and into an aperture 4 of the insertion needle 5 (see FIG. 2). An exemplary tuft feed unit is described in European Patent No. EP1474354. Alternatively, a tuft feed unit may be a rodless air cylinder, or any other suitable unit. The insertion needle 5 then inserts the tuft 1 into the mattress (downwardly in the arrangement shown in FIG. 2, although any orientation is possible).

Referring to FIGS. 3a and 3b, the apparatus of the present invention is designed to enable a tuft 1a, 1b, 1c of the required length to be selected from a plurality of tuft strings 2a, 2b, 2c, respectively for locating in the aperture 4 of an insertion needle 5. Each tuft string 2a, 2b, 2c comprises tufts 1a, 1b, 1c respectively of a different length to the tufts 1a, 1b, 1c of another tuft string 2a, 2b, 2c. In this embodiment, each tuft string 2a, 2b, 2c is fed into a dedicated tuft feed unit (not shown). That is, a plurality of tufts la of a first length form a first tuft string 2a, wherein the first tuft string 2a is fed into a first tuft feed unit (not shown) and a plurality of tufts 1b of a second length form a second tuft string 2b, the second tuft string 2b being fed into a second tuft feed unit. The same arrangement is used in respect of a third tuft string 3c made up of a plurality of tufts 1c. While three tuft strings are shown, any number can be utilised with the apparatus and method of the present invention.

The plurality of tuft feed units is actuated to selectively align one of the plurality of tuft feed units with the tuft feed axis 3 to enable a required length of tuft 1 to be inserted into the aperture 4 of the insertion needle 5. The required length of tuft 1 is determined according to the depth of the mattress to be tufted and the desired residual tension in the mattress at the point at which the tuft is inserted. In this embodiment, the insertion needle 5 remains stationary as the plurality of tuft feed units supporting the tuft strings 2 are actuated so that tufts of the correct length can be fed to the insertion needle 5. The selection and actuation of the appropriate tuft feed unit may be achieved pneumatically, hydraulically, electrically or by any other suitable means. The actuator may be controlled by a servo, or by any other suitable means.

In one embodiment, the plurality of tuft feed units are arranged so that the tuft strings extend parallel to one another and the selection of the appropriate tuft feed unit occurs by linear movement of the tuft feed units as described below. The tuft feed units may be arranged vertically, horizontally, or otherwise. In a first position, shown in FIG. 3a, the first tuft feed unit is orientated so that the first tuft string 2a is aligned with the tuft feed axis 3. When it is desired to insert a different length tuft (shorter in the embodiment shown in FIGS. 3a and 3b), the actuator causes the first tuft feed unit to move the first tuft string 2a linearly upwards out of alignment with the tuft feed axis 3. The actuator then moves the second tuft feed unit linearly upwards to bring the second tuft string 2b into alignment with the tuft feed axis 3, as shown in FIG. 3b.

In another embodiment shown in FIG. 4, a plurality of tuft feed units (not shown) are arranged circumferentially around an arbitrary axis (not marked on FIG. 4). A tuft feed axis 3 is aligned with a point on the circumference on which the plurality of tuft feed units are arranged. In a first position, the first tuft feed unit orientated so that the first tuft string 2a is aligned with the tuft feed axis 3. When it is desired to insert a different length tuft, the actuator (not shown) rotates the plurality of tuft feed units around the arbitrary axis, i.e. along the aforementioned circumference, so that movement of the first tuft feed unit causes the first tuft string 2a to move out of alignment with the tuft feed axis 3 and the second tuft feed unit moves to bring a second tuft string 2b in to alignment with the tuft feed axis 3 ready for insertion into an aperture in an insertion needle (not shown).

In another embodiment shown in FIG. 5, the tuft feed units (not shown) are arranged radially around a tuft feed axis 3. In a first position, a first tuft feed unit is orientated so that the first tuft string 2a is aligned with the tuft feed axis 3. When it is desired to insert a different length tuft, the actuator (not shown) moves the first tuft feed unit radially outward, to move the first tuft string 2a out of alignment with the tuft feed axis 3, and the actuator then moves a second tuft feed unit radially inward to bring the second tuft string 2b into alignment with the tuft feed axis 3 ready for insertion into an aperture in an insertion needle (not shown).

In each of the aforementioned embodiments, the second (or subsequent) tuft feed unit is selected and aligned with the tuft feed axis 3 by the actuator according to the length of tuft required to be inserted according to the depth of the mattress (or region of the mattress) to be tufted.

In an alternative embodiment, the actuator is used to move the insertion needle 5 to different positions relative to the plurality of tuft feed units, thereby aligning the tuft feed axis 3 with the selected tuft feed unit, i.e. the plurality of tuft feed units remains stationary as the insertion needle 5 is move by the actuator. In a first position, the tuft feed axis 3 is aligned with a first of the plurality of tuft feed units. The insertion needle 5 then moves to a second (or subsequent) position wherein the tuft feed axis 3 is aligned with a second (or subsequent) tuft feed unit supporting tufts of a different length. The second (or subsequent) position will be selected as required according to the length of tuft required for the mattress (or region of mattress) to be tufted. By way of example, the insertion needle 5 may be suspended from a gantry and moved around said gantry to change position relative to the tuft feed units.

The process of selecting the required length of tuft for the mattress being tufted is carried out by a selector. The selector may be automatic, for example a reader to read a product identification on a mattress to be tufted, such as a barcode or radio frequency (RF) chip. Alternatively, the selector may be a manual operation wherein an operator may select the length of tuft required based on the identification of the mattress to be tufted. The selector may be a pre-programmed selector that selects the length of tuft required according to a manually selected pre-programmed tuft pattern. A controller will control the actuator according to the output of the selector.

It will be appreciated that it may be desired to insert tufts of a single length into a mattress or it may be desirable to insert tufts of different lengths into the same mattress, for example, to define regions of the mattress with greater or lesser tension and thereby firmness.

1. An upholstery tufting apparatus comprising:
an insertion needle comprising an aperture to receive a tuft for insertion into an article to be upholstered, wherein, in use, the tuft is presented to the aperture of the insertion needle along a tuft feed axis,
a plurality of tuft strings including a first tuft string comprising a plurality of tufts of a first length and a second tuft string comprising a plurality of tufts of a second length which is different to said first length,
one or more tuft feed units, and
an actuator operatively connected to said one or more tuft feed units;
wherein the first tuft string and the second tuft string are associated with said one or more tuft feed units; and
wherein a selected one of said one or more tuft feed units is actuatable by the actuator to align one of the first and second tuft strings with the tuft feed axis according to the length of tuft required, in use, to be inserted into the article to be upholstered.

2. An upholstery tufting apparatus according to claim 1 wherein there is provided a plurality of tuft feed units, a first tuft feed unit of said plurality of tuft feed units associated with the first tuft string and a second tuft feed unit of said plurality of tuft feed units associated with the second tuft string.

3. An upholstery tufting apparatus according to claim 2 wherein the plurality of tuft feed units are arranged in a linear array.

4. An upholstery tufting apparatus according to claim 3 wherein the actuator is operated, in use, to move the linear array of tuft feed units so as to align the tuft feed string associated with the selected one of the plurality of tuft feed units with the tuft feed axis.

5. An upholstery tufting apparatus according to claim 3 wherein the actuator is operated, in use, to move the selected one of the plurality of tuft feed units so as to align the tuft feed string associated with said selected one of the plurality of tuft feed units with the tuft feed axis.

6. An upholstery tufting apparatus according to claim 2 wherein the plurality of tuft feed units are arranged in an array around the tuft feed axis.

7. An upholstery tufting apparatus according to claim 6 wherein the actuator is operated, in use, to move the selected one of the plurality of tuft feed units to align the tuft feed string associated with said selected one of the plurality of tuft feed units with the tuft feed axis.

8. An upholstery tufting apparatus according to claim 2 wherein the plurality of tuft feed units are arranged in a circular array around the tuft feed axis.

9. An upholstery tufting apparatus according to claim 8 wherein the actuator is operated, in use, to move the selected one of the plurality of tuft feed units in a radial direction to align the tuft feed string associated with said selected one of the plurality of tuft feed units with the tuft feed axis.

10. An upholstery tufting apparatus according to claim 2 wherein the plurality of tuft feed units are arranged in a circular array centred on an axis which is offset from said tuft feed axis and which extends parallel to the tuft feed axis, the tuft feed axis being aligned with a point on a circle defined by said circular array.

11. An upholstery tufting apparatus according to claim 10 wherein the actuator is operated, in use, to rotate the circular array of tuft feed units so as to align the tuft feed string associated with the selected one of the plurality of tuft feed units with the tuft feed axis.

12. An upholstery tufting apparatus according to claim 1 wherein the or each of said one or more tuft feed units comprises a rodless air cylinder.

13. An upholstery tufting apparatus according to claim 1 wherein the actuator is a pneumatic actuator.

14. An upholstery tufting apparatus according to claim 1 further comprising a selector and a controller, wherein the selector determines the length of tuft required for insertion into said article to be upholstered and selects an output according to the determined length of tuft required, and the controller controls the actuator according to the output of the selector.

15. An upholstery tufting apparatus according to claim 14 wherein the controller is a servo controller.

16. A method for tufting an upholstered article using apparatus according to claim 1, wherein the method comprises the steps of:
operating a selector to select the length of tuft required to be inserted into the upholstered article;
operating a controller to control the actuator, according to the length of tuft selected by the selector, to move said selected one of said one or more tuft feed units to align said one of the first and second tuft strings with the tuft feed axis according to the selected length of tuft to be inserted into the article to be upholstered; and
operating the tuft insertion needle to insert the tuft of the selected length into the upholstered article.

17. An upholstery tufting apparatus comprising:
an insertion needle comprising an aperture to receive a tuft for insertion into an article to be upholstered, wherein, in use, the tuft is presented to the aperture of the insertion needle along a tuft feed axis,
a plurality of tuft strings including a first tuft string comprising a plurality of tufts of a first length and a second tuft string comprising a plurality of tufts of a second length,
one or more tuft feed units, and
an actuator operatively connected to the insertion needle;
wherein the first tuft string and the second tuft string are associated with said one or more tuft feed units; and
wherein the insertion needle is actuatable by the actuator to align the tuft feed axis with a selected one of the first and second tuft strings according to the length of tuft required, in use, to be inserted into the article to be upholstered.

18. A method for tufting an upholstered article using apparatus according to claim 17, wherein the method comprises the steps of:
operating a selector to select the length of tuft required to be inserted into the upholstered article;
operating a controller to control the actuator, according to the length of tuft selected by the selector, to move said insertion needle to align the tuft feed axis with the selected one of the first and second tuft strings according to the selected length of tuft to be inserted into the article to be upholstered; and
operating the tuft insertion needle to insert the tuft of the selected length into the upholstered article.
